(19) United States
(12) Patent Application Publication
(10) Pub. No.: US 2021/0073726 A1
(43) Pub. Date: Mar. 11, 2021

(54) DELIVERY SUPPORT SYSTEM AND DELIVERY SUPPORT PROGRAM

(71) Applicant: AISIN AW CO., LTD., Anjo-shi (JP)

(72) Inventors: Kazuhiro OKODO, Setagaya (JP); Yoichi YAMAMURA, Okazaki (JP); Toshiyuki SEKI, Okazaki (JP); Toyohide TSUBOI, Okazaki (JP)

(73) Assignee: AISIN AW CO., LTD., Anjo-shi (JP)

(21) Appl. No.: 16/993,504

(22) Filed: Aug. 14, 2020

(30) Foreign Application Priority Data
Sep. 10, 2019 (JP) 2019-164338

(51) Int. Cl. G06Q 10/08; G06K 9/32; B65B 35/30

(52) U.S. Cl. CPC G06Q 10/0832; B65B 35/30; G06K 9/3233

(57) ABSTRACT

Configured is a delivery support system including: an available space detection unit that detects an available space that is a space in which a package can be loaded based on an output signal of a package sensor that is attached to a package compartment provided in a delivery vehicle and that detects a three-dimensional region in which there is a package loaded in the package compartment; a determination unit that determines whether a package to be added can be loaded in the available space based on dimensions of the package to be added; and an output unit that outputs a determination result of whether a package can be loaded.

### INCORPORATION BY REFERENCE

The disclosure of Japanese Patent Application No. 2019-164338 filed on Sep. 10, 2019 including the specification, drawings and abstract is incorporated here by reference in its entirety.

### BACKGROUND

### 1. Field

The disclosure relates to a delivery support system and a delivery support program.

### 2. Description of Related Art

Conventionally, a system that supports delivery in a delivery vehicle is known. For example, Japanese Unexamined Patent Application Publication No. 2003-104560 (JP 2003-104560 A) discloses a technique that extracts a type of transportation unit with the lowest fare from a plurality of types of transportation units, based on information of the size and weight of the product, and information of whether loading a package on top of the product is permitted. Also, JP 2003-104560 A discloses three-dimensionally displaying the loading availability of the transportation unit so that users are able to confirm what kind of space is available in a three-dimensional manner.

### SUMMARY

In the related art, it is difficult to specify whether a package can actually be loaded in a delivery vehicle. That is, in JP 2003-104560 A, it is disclosed that the size of the product is registered. However, whether a package can be loaded in a package compartment is not determined only by the size of the product. For example, even if the size of the package is the same, the available space is changed depending on how the package is arranged. In the related art, since the actual situation of the package in the package compartment is unknown, whether the package can actually be loaded is not accurately known.

Exemplary embodiment has been made in view of the above problems, and has an object to provide a system capable of increasing the possibility of accurately determining whether a package can be loaded in a package compartment.

To achieve the above objective, a delivery support system includes: an available space detection unit that detects an available space that is a space in which a package can be loaded based on an output signal of a package sensor that is attached to a package compartment provided in a delivery vehicle and that detects a three-dimensional region in which there is a package loaded in the package compartment; a determination unit that determines whether a package to be added can be loaded in the available space based on dimensions of the package to be added; and an output unit that outputs a determination result of whether a package can be loaded.

Also, a delivery support program causes a computer to function as: an available space detection unit that detects an available space that is a space in which a package can be loaded based on an output signal of a package sensor that is attached to a package compartment provided in a delivery vehicle and that detects a three-dimensional region in which there is a package loaded in the package compartment; a determination unit that determines whether a package to be added can be loaded in the available space based on dimensions of the package to be added; and an output unit that outputs a determination result of whether a package can be loaded.

That is, in the delivery support system and the delivery support program, the available space is specified by actually measuring the three-dimensional region in which there is the package with the package sensor that is attached to the package compartment. As a result, it is possible to increase the possibility of accurately determining whether the package can be loaded in the package compartment.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram of a delivery support system;

FIG. 2A and FIG. 2B illustrate examples of the arrangement of package sensors; and

FIG. 3A is a flowchart of an available space acquisition process and FIG. 3B is a flowchart of a delivery support process.

### DETAILED DESCRIPTION OF THE EXEMPLARY EMBODIMENTS

Hereinafter, embodiments of the will be described in the following order.

### (1) Configuration of Delivery Support System

### (2) Available Space Acquisition Process

### (3) Delivery Support Process

### (4) Other Embodiments

### (1) Configuration of Delivery Support System

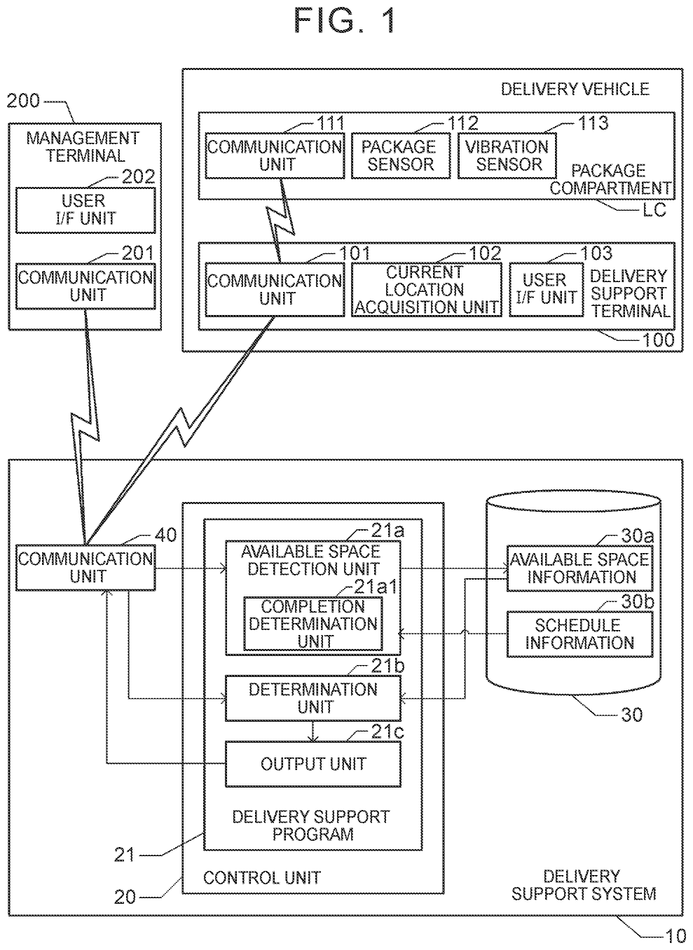

FIG. 1 is a block diagram illustrating a configuration of a delivery support system 10 according to the embodiment. In the present embodiment, a manager belonging to a management company that manages a plurality of delivery vehicles creates a delivery schedule for each delivery vehicle and assigns the delivery schedule to the delivery vehicle. In the present embodiment, each delivery vehicle travels along a route indicated by schedule information indicating the delivery schedule, delivers a package to a package delivery location during a traveling process, and loads a package at a collection location. The route may be a predetermined delivery and collection route or a route determined according to the package.

Further, in the present embodiment, the delivery schedule may be changed during the traveling process of the delivery vehicle. That is, the manager of the management company receives a package delivery request from a consignor at all times. The manager of the management company selects the delivery vehicle capable of loading a received package in a package compartment, changes the schedule information of the selected delivery vehicle, and notifies a delivery person driving the delivery vehicle. As a result, the delivery person drives the delivery vehicle to a new package collection location, adds the package to the package compartment, and performs delivery according to a new delivery schedule.

In order to operate the system described above, it is necessary to specify whether a package can be added to the package compartment in each delivery vehicle in the middle of delivery. The delivery support system 10 is a system that specifies whether a package can be added to the package compartment. The delivery support system 10 cooperates with a management terminal 200 and components in the delivery vehicle (such as a delivery support terminal 100 and a package sensor 112).

The management terminal 200 is a terminal used by the manager. For example, the management terminal 200 is configured of a stationary general-purpose computer, a mobile terminal, or the like. The management terminal 200 can execute a program not shown with a control unit not shown. In the present embodiment, the management terminal 200 can execute a management program as the program. While the management program is being executed, the management terminal 200 generates and updates etc. the schedule information of the delivery vehicle. The management terminal 200 includes a communication unit 201 and a user I/F unit 202.

The communication unit 201 includes a circuit that communicates with another device. In the present embodiment, the management terminal 200 can communicate with the delivery support system 10 via the communication unit 201. The user I/F unit 202 is an interface unit for providing various types of information to the manager and receiving a command from the manager. For example, the user I/F unit 202 includes an output unit such as a display or a speaker, and an input unit such as a keyboard or a mouse. The management terminal 200 can control the output unit to display various types of information. In addition, the manager can perform various inputs with the input unit. The management terminal 200 can acquire a command from the manager based on the input.

The delivery vehicle is a vehicle (for example, a truck) having the package compartment. The delivery person that drives the delivery vehicle can use the delivery support terminal 100 that notifies the delivery person of a route for following the schedule information. The delivery support terminal 100 may be an in-vehicle terminal or a mobile terminal. The delivery support terminal 100 executes a program not shown with a control unit not shown and proposes the route for following the schedule information indicating the delivery schedule. That is, the schedule information includes destinations of the delivery vehicle, the order of the destinations, and the route for visiting the destinations in the order. The delivery support terminal 100 proposes information indicating the route for visiting destinations in order, a package handling type (unloading, loading, or loading and unloading) at each destination, and the package to be handled.

The delivery support terminal 100 includes a communication unit 101, a current location acquisition unit 102, and a user I/F unit 103. The communication unit 101 includes a circuit that communicates with another device. In the present embodiment, the delivery support terminal 100 can communicate with a communication unit 111 provided in the package compartment and the delivery support system 10 via the communication unit 101.

The current location acquisition unit 102 is a sensor that acquires the current location of the delivery support terminal 100 (equivalent to the current location of the delivery vehicle). The current location acquisition unit 102 can be configured of a GNSS signal receiving unit that acquires the current location based on output signals from navigation satellites, a vehicle speed sensor and a gyro sensor that specify a movement path of the delivery vehicle etc., for example. As a matter of course, the sensor may be configured of all of these, or may be a sensor that specifies the current location with another method.

The user I/F unit 103 is an interface unit for providing various types of information to the delivery person that drives the delivery vehicle and for inputting a command from the delivery person. In the present embodiment, the user I/F unit 103 is a touch panel display. That is, the delivery support terminal 100 can control the touch panel display to display various types of information. Further, the delivery person can perform various inputs by touch operation. The delivery support terminal 100 can acquire the command from the delivery person based on the input.

A package compartment LC of the delivery vehicle is provided with the communication unit 111, the package sensor 112, and a vibration sensor 113. The communication unit 111 can communicate with the communication unit 101 of the delivery support terminal 100. The communication unit 111 can transmit a detection result of the package sensor 112 and a detection result of the vibration sensor 113 to the delivery support terminal 100. The package sensor 112 is a sensor that is attached to the package compartment LC and that detects a three-dimensional region in which there is the package loaded in the package compartment LC. In the present embodiment, the package sensor 112 is attached to an inner wall of the package compartment LC. The package sensor 112 is an infrared sensor. In the present embodiment, the package sensor 112 detects a distance from the package sensor 112 to the package. That is, the package sensor 112 is capable of outputting infrared rays toward a predetermined detection range, and measures the distance between the package sensor 112 and the package by detecting the infrared rays reflected by the package. Obviously, the package sensor 112 may use various types of methods.

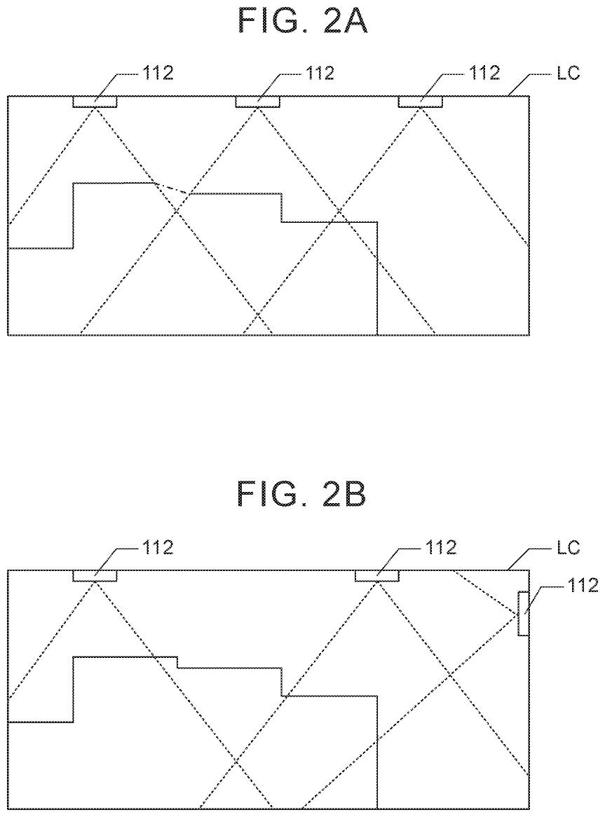

FIG. 2A illustrates an example of a relationship between the package compartment LC and the package sensors 112. In FIG. 2A, the package sensors 112 are attached to three places on a top surface that is a part of the inner wall of the package compartment LC. Broken lines indicate the ranges in which infrared rays are emitted from the package sensors 112. The package sensors 112 can detect the distance between the package sensors 112 and the package within the emitting range. Since a height of an internal space of the package compartment LC is known, if the distance between the package and the package sensors 112 is specified, the height of the package in the package compartment LC from the bottom surface can be specified.

FIG. 2A schematically illustrates an example of the detected height of the package with solid lines. The height of the package is not specified in a part outside the detection range of the package sensors 112. However, in this part, the height of the package may be regarded as being constant inside and outside the detection range, or may be interpolated based on the detection results of different package sensors 112. FIG. 2A illustrates with a long dashed short dashed line, the interpolation result acquired by connecting the parts having the height acquired by the detection results of the adjacent package sensors 112 with a straight line extended in a specific direction (for example, a front-rear direction of the package compartment LC (right-left direction in FIG. 2A)).

As described above, the package sensor 112 can detect the distance from the package sensor 112 to the package. In this way, the three-dimensional region in which there is the package can be detected by the height of the package in the package compartment. As a matter of course, positions and the number of the package sensors 112 are not limited, and can be various values according to the required accuracy etc. For example, as illustrated in FIG. 2B, the configuration may be such that the package sensors 112 are attached to the top surface and a side surface.

The vibration sensor 113 is a sensor that detects vibration in the delivery vehicle. In the present embodiment, the vibration sensor 113 is attached to the package compartment LC. The vibration sensor 113 may be any sensor that can detect vibration, and is a sensor that detects acceleration applied to the package compartment LC in the present embodiment. In the present embodiment, the vibration sensor 113 is a sensor that detects acceleration applied to the package compartment LC in three axial directions. If an excessively large acceleration is applied to the package compartment LC while the delivery vehicle is traveling and vibration is generated, the position of the package in the package compartment LC etc. may be changed. In the present embodiment, the vibration sensor 113 is provided to specify a situation in which the loading state of the package may be changed. Thus, as long as the state in which the loading state of the package may be changed can be specified, a state and an attachment position of the vibration sensor 113 is not limited. Further, an acceleration sensor having another purpose may be used as the vibration sensor 113, or a vibration sensor other than an acceleration sensor may be used as the vibration sensor 113.

The delivery support system 10 can update the delivery schedule information by cooperating with the management terminal 200, the delivery support terminal 100, and the package sensor 112 etc. described above. The delivery support system 10 includes a control unit 20, a recording medium 30, and a communication unit 40. The communication unit 40 includes a circuit that communicates with another device. The control unit 20 can communicate with the management terminal 200 and the delivery support terminal 100 via the communication unit 40.

Various kinds of information can be recorded in the recording medium 30. In the present embodiment, available space information 30a is recorded during the operation of the delivery support system 10. Schedule information 30b generated beforehand by the manager is recorded in the recording medium 30. The schedule information 30b is information indicating the delivery schedule of each delivery vehicle. In the present embodiment, the schedule information 30b is defined for each delivery vehicle ID, and the route to be traveled when performing delivery is associated with the delivery vehicle ID. The route of each delivery vehicle includes a plurality of destinations and an order of visits, and includes package handling types (unloading, loading, or loading and unloading) and the package to be handled at each destination.

The schedule information 30b is transmitted to each delivery vehicle before each delivery vehicle starts delivery. The delivery support terminal 100 proposes the route indicated by the schedule information 30b. In the present embodiment, the schedule information 30b is created beforehand by the manager operating the user I/F unit 202 of the management terminal 200 etc., transmitted to the delivery support system 10, and recorded in the recording medium 30.

The control unit 20 has a control processing unit (CPU), a random access memory (RAM), and a read-only memory (ROM) etc. that are not shown, and can execute a program recorded in the recording medium 30. In the present embodiment, a delivery support program 21 is included in this program. The delivery support program 21 includes an available space detection unit 21a, a determination unit 21b, and an output unit 21c. The available space detection unit 21a is a program module that causes the control unit 20 to execute a function of detecting an available space that is a space in which the package can be loaded, based on output signals of the package sensor that is attached to the package compartment provided in the delivery vehicle, and that detects a three-dimensional region in which there is the package loaded in the package compartment.

In the present embodiment, the package sensor 112 is attached to the package compartment LC of the delivery vehicle. Thus, the control unit 20 acquires the detection result of the package sensor 112 by making a transmission request to the delivery support terminal 100. That is, the control unit 20 outputs the transmission request of the detection result of the package sensor 112 to the delivery vehicle via the communication unit 40. When the delivery support terminal 100 acquires the transmission request via the communication unit 101, the delivery support terminal 100 outputs a control signal for the package sensor 112 via the communication unit 101. The communication unit 111 acquires the control signal, drives the package sensor 112 to acquire a detection result, and transmits the detection result to the communication unit 101. The delivery support terminal 100 transmits the detection result to the delivery support system 10 via the communication unit 101.

The control unit 20 acquires the detection result via the communication unit 40. The detection result of the package sensor 112 indicates the distance between the package and the package sensor 112. Thus, the control unit 20 acquires the height of the package from the bottom surface of the package compartment based on the known height of the internal space of the package compartment LC. If the height of the package from the bottom surface is specified, the space that remains after excluding a part having a height equal to or less than the specified height from the empty package compartment can be regarded as the available space. Then, the control unit 20 records information indicating the available space in the recording medium 30 as the available space information 30a. In the present embodiment, the package sensor 112 of each delivery vehicle is driven according to a predetermined trigger, and the available space information 30a is acquired. There can be various triggers set as the trigger. For example, the trigger may be artificially generated by a command from the manager etc., or the trigger may be generated by the delivery support system 10, the delivery support terminal 100, and the management terminal 200 etc. based on a predetermined condition. In order to generate at least a part of the latter trigger, in the present embodiment, the available space detection unit 21a includes a completion determination unit 21a1. The details of the completion determination unit 21a1 will be described later.

The determination unit 21b is a program module that causes the control unit 20 to execute a function of determining whether the package to be added to the available space can be loaded, based on dimensions of the package to be added. In the present embodiment, since a plurality of the delivery vehicles may be operated simultaneously in the operation process, when a new package delivery request is received, a vehicle to load the new package is selected from the delivery vehicles. For this purpose, the control unit 20 acquires from the management terminal 200, information of the package for which the delivery request has been received. That is, when the new delivery request is received, the manager of the management terminal 200 acquires information of the collection location and the delivery location of the package from the consignor, and further acquires information of the dimensions of the package.

The dimensions of the package only need to indicate the minimum three-dimensional size that is necessary when loading the package in the package compartment. In the present embodiment, the size is specified by a width, a height, and a depth of the smallest rectangle circumscribing the package when the package is loaded. There are various states for the state in which the package is loaded. For example, the state may be such that an object having a complicated shape such as a bumper of a vehicle is placed on a rectangular box having an open top surface. There may a case in which another package cannot be loaded on top of the package. In this case, the information indicating the package includes information such as prohibiting loading another package on top of the package. In any case, with the function of the determination unit 21b, the control unit 20 acquires from the management terminal 200, the information of the package (the collection location, the delivery location, and the dimensions of the package) for which the delivery request has been received.

Further, the control unit 20 refers to the schedule information 30b recorded in the recording medium 30, and specifies the delivery vehicle that is a candidate for loading a new package based on predetermined conditions. These conditions may be various conditions. For example, the condition may set as a candidate, the delivery vehicle that is at a distance within a predetermined range from the new package collection location, or may set as a candidate, the delivery vehicle having time to spare due to the delivery vehicle having a small number of packages scheduled to be delivered.

When the candidate delivery vehicle is specified, the control unit 20 acquires the available space information 30a indicating the current available space of the candidate delivery vehicle. Then, the control unit 20 compares the available space information and 30a and the dimensions of the new package, and determines that the new package can be loaded in the available space when the space defined by the dimensions is included in the available space. When it is determined that the new package can be loaded, the control unit 20 specifies that the candidate delivery vehicle is a vehicle in which the new package can be loaded. It is a matter of course that the space considered as the available space may be limited based on information of prohibiting loading another package on top of the package, for example.

The output unit 21c is a program module that causes the control unit 20 to execute a function of outputting a determination result of whether the package can be loaded. In the present embodiment, the control unit 20 notifies the manager of the delivery vehicle that is specified to be capable of having the new package loaded by the determination of the determination unit 21b. For this purpose, the control unit 20 transmits information indicating the delivery vehicle specified to be capable of having the new package loaded, to the management terminal 200 via the communication unit 40.

As a result, the management terminal 200 displays information of the delivery vehicle specified to be capable of having the new package loaded, on an output unit of the user I/F unit 202. When the information of the delivery vehicle is output, at least information (such as an ID) indicating the delivery vehicle is required to be output. However, the output mode is not limited to this, and various modes may be adopted. For example, from the delivery support terminal 100 or the delivery support system 10, the available space information 30a of each delivery vehicle and information indicating the height of the package may be transmitted to the management terminal 200 to be displayed. The current location of each delivery vehicle and the schedule information 30b of each delivery vehicle may be transmitted from the delivery support terminal 100 or the delivery support system 10 to the management terminal 200 to be displayed.

In any case, the manager designates the delivery vehicle in which the new package is to be loaded, based on the display on the output unit of the user I/F unit 202. When the delivery vehicle is designated, the management terminal 200 transmits information indicating the designated delivery vehicle to the delivery support system 10 via the communication unit 201. The delivery support system 10 acquires the information indicating the delivery vehicle via the communication unit 40 and updates the schedule information 30b of the delivery vehicle.

Specifically, the control unit 20 adds the new package collection location and the new package delivery location as the destinations after the current location of the delivery vehicle, and searches for a route including the destinations based on the map information not shown. The control unit 20 then associates the searched route with the ID of the delivery vehicle, associates the order of visiting each destination, the handling type at each destination, and the package to be handled at each destination, and then updates the schedule information 30b. When the schedule information 30b is updated, the control unit 20 transmits the schedule information 30b via the communication unit 40 to the delivery support terminal 100 of the delivery vehicle whose schedule information 30b has been updated. The delivery support terminal 100 acquires the transmitted schedule information 30b and proposes the route indicated by the schedule information 30b. The above resetting of the schedule information 30b may be executed by the management terminal 200 or the delivery support terminal 100.

In the present embodiment as described above, the available space in the package compartment LC of the delivery vehicle is actually measured by the package sensor 112 attached to the package compartment LC of the delivery vehicle. Thus, there is a high possibility that it is accurately determined whether the package can be loaded in the package compartment LC. Therefore, there is a high possibility that it is possible to suppress an inconvenience from occurring, such as it becoming clear that the package cannot be loaded in the package compartment LC after the delivery vehicle for delivering the new package visits the collection location and receives the package.

### (2) Available Space Acquisition Process

Next, an available space acquisition process executed by the control unit 20 with the function of the available space detection unit 21a will be described. In the present embodiment, it is possible to drive the package sensor 112 with various triggers to detect the available space. Specifically, detection of the available space is executed when a scanning command is issued by the manager of the management terminal 200, when a loading operation in the package compartment LC is completed, when an unloading operation from the package compartment LC is completed, and when a vibration exceeding a criterion is detected in the vehicle.

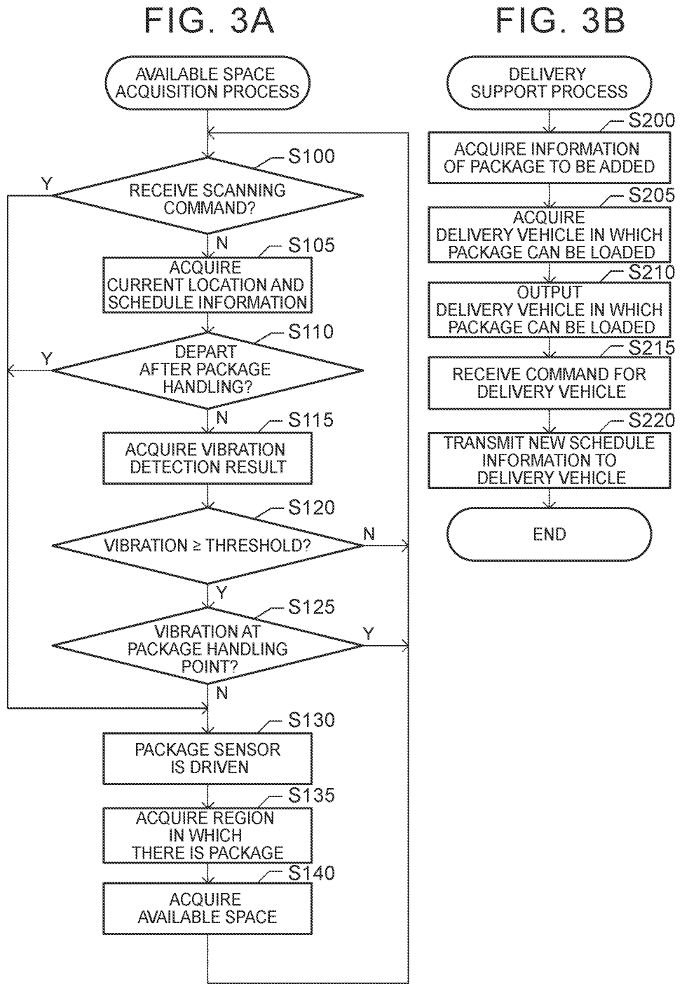

The control unit 20 detects the available space with these triggers by executing the available space acquisition process shown in FIG. 3A. Specifically, the control unit 20 monitors the communication unit 40 and determines whether a scanning command has been received (step S100). That is, the manager of the management terminal 200 can operate an input unit of the user I/F unit 202 at a desired timing to issue a command to acquire the available space in each of the desired delivery vehicles. When the command is issued, the management terminal 200 transmits the scanning command with the IDs of the delivery vehicles via the communication unit 201. The control unit 20 monitors communication in the communication unit 40 and determines whether the scanning command has been received.

When it is determined in step S100 that the scanning command has been received, the control unit 20 executes the processes in and after step S130 for the desired delivery vehicles. In contrast, when it is not determined in step S100 that the scanning command has been received, the control unit 20 performs determination with the completion determination unit 21a1. In the present embodiment, the completion determination unit 21a1 is a program module that causes the control unit 20 to execute a function of determining whether the loading operation or the unloading operation (package handling) in the package compartment is completed. With the function of the completion determination unit 21a1, the control unit 20 acquires the current location and the schedule information of each of the delivery vehicles (step S105). That is, the control unit 20 sends a transmission request of the current location to each of the delivery vehicles via the communication unit 40. When the delivery support terminal 100 acquires the transmission request via the communication unit 101, the delivery support terminal 100 acquires the current location of the delivery vehicle based on the current location acquisition unit 102. The delivery support terminal 100 associates the ID of the delivery vehicle with the current location and transmits the current location via the communication unit 101. The control unit 20 acquires the current location of each of the delivery vehicles via the communication unit 40. Further, the control unit 20 refers to the recording medium 30 and acquires the schedule information 30b of each of the delivery vehicles.

Next, the control unit 20 determines whether the delivery vehicle has departed after package handling, with the function of the completion determination unit 21a1 (step S110). That is, when the package handling (unloading, loading, or loading and unloading operation) is completed in the delivery vehicle, there is a high possibility that the available space has changed compared to before the package handling was performed. Thus, the control unit 20 determines whether the current location acquired in step S105 is on the route immediately after the destination at which package handling should be performed for each of delivery vehicles based on the schedule information 30b. When the current location is on the route immediately after the destination at which package handling should be performed, the control unit 20 determines that the delivery vehicle has departed after package handling (package handling is completed). The control unit 20 performs the above determination for each of the delivery vehicles. In step S110, when it is determined that the delivery vehicle has departed after package handling, the control unit 20 executes the processes in and after step S130 for each of the delivery vehicles that is determined to have departed after package handling.

In contrast, when it is not determined in step S110 that the delivery vehicle has departed after package handling, the control unit 20 acquires a detection result of vibration applied to the delivery vehicle (step S115). That is, control unit 20 sends a transmission request of the vibration detection result to each of the delivery vehicles via the communication unit 40. When the delivery support terminal 100 acquires the transmission request via the communication unit 101, the delivery support terminal 100 refers to the history in the vibration sensor 113.

That is, the vibration sensor 113 continuously detects vibration (acceleration) applied to the delivery vehicle, and when vibration greater than a threshold is applied to the delivery vehicle, information indicating that vibration greater than the threshold is applied to the delivery vehicle is transmitted from the communication unit 111 to the delivery support terminal 100. When the information indicating that vibration greater than the threshold is applied is transmitted, the delivery support terminal 100 acquires the current location of the delivery vehicle based on the output signal of the current location acquisition unit 102. Then, the delivery support terminal 100 associates the current location with the information indicating that vibration greater than the threshold is applied, and records the information as the history on a recording medium not shown.

When the transmission request of the vibration detection result is acquired, the delivery support terminal 100 transmits the information recorded in the history to the delivery support system 10 via the communication unit 101. The control unit 20 acquires the information as the vibration detection result via the communication unit 40. The control unit 20 executes the process described above of acquiring the vibration detection result for each of the delivery vehicles.

Next, the control unit 20 determines whether there is the delivery vehicle in which vibration is equal to or greater than the threshold (step S120). That is, when the detection result is acquired for at least one delivery vehicle in step S115, the control unit 20 determines that there is a delivery vehicle in which vibration is equal to or greater than the threshold. When it is not determined in step S120 that there is a delivery vehicle in which vibration is equal to or greater than the threshold, the control unit 20 repeats the processes in and after step S100.

When it is determined in step S120 that there is a delivery vehicle in which vibration is equal to or greater than the threshold, it is determined whether the point at which vibration equal to or greater than the threshold is applied to the delivery vehicle is a package handling point (step S125). That is, the control unit 20 refers to the schedule information 30b of the delivery vehicle, and when the destination on the route matches the current location associated with the vibration detection result acquired in step S115, the control unit 20 determines that the point at which vibration equal to or greater than the threshold value is applied is the package handling point. The control unit 20 performs the above determination for each of the delivery vehicles to which vibration equal to or greater than the threshold is applied.

At the package handling point, large vibration may be applied to the delivery vehicle and the package compartment LC due to the loading and unloading of the package. Further, a change in the available space associated with loading and unloading of the package is taken into consideration by the determination in step S110. Thus, when it is determined in step S125 that the point at which vibration equal to or greater than the threshold is applied is the package handling point, the control unit 20 executes the process in and after step S100.

In contrast, when it is not determined in step S125 that the point at which vibration equal to or greater than the threshold is applied is the package handling point, it is estimated that vibration is applied to the delivery vehicle due to an uneven road surface, sudden braking, or sudden steering etc. while the delivery vehicle is traveling. In this case, there is a possibility that the available space is changed. Here, the control unit 20 executes step S130 and onward for the delivery vehicle in which it is not determined that the point at which vibration equal to or greater than the threshold is applied is the package handling point.

In and after step S130, the control unit 20 performs a process for acquiring the available space. Specifically, the control unit 20 sends a transmission request of the detection result of the package sensor 112 for each of the target delivery vehicles via the communication unit 40. When the delivery support terminal 100 acquires the transmission request via the communication unit 101, the delivery support terminal 100 outputs a control signal for the package sensor 112 via the communication unit 101. The control signal is acquired by the communication unit 111, and the package sensor 112 is driven as a result.

When the package sensor 112 is driven, the package sensor 112 acquires the detection result indicating the distance between the package sensor 112 and the package, for the package in the package compartment LC. The detection result is transmitted to the delivery support terminal 100 by the communication unit 111. The delivery support terminal 100 transmits the detection result to the delivery support system 10 via the communication unit 101. The control unit 20 acquires the detection result via the communication unit 40.

When the control unit 20 acquires the detection result, the control unit 20 acquires a region in which there is the package (step S135). That is, since the detection result of the package sensor 112 indicates the distance between the package and the package sensor 112, the control unit 20 acquires the height of the package from the bottom surface of the package compartment LC based on the known height of the package compartment LC. When the height of package from the bottom surface of the package compartment LC is specified for the entire bottom surface of the package compartment LC, the region in which there is the package is acquired.

Next, the control unit 20 acquires the available space (step S140). That is, control unit 20 assumes that the space that remains after excluding the region in which there is the package from the space of the empty package compartment LC is the available space. The control unit 20 then records information indicating the available space in the recording medium 30 as the available space information 30a. The above processing is performed for each of the target delivery vehicles, so that even if the available space of each of the delivery vehicles is changed, information of actual measurements of the available space after the change is maintained.

### (3) Delivery Support Process

Next, a delivery support process will be described with reference to the flowchart shown in FIG. 3B. Execution of the delivery support process in the present embodiment is started when the management terminal 200 which received a new request for package delivery transmits information of the package for which the delivery request has been received. When the delivery support processing is started, the control unit 20 acquires information of the package to be added with a function of the determination unit 21b (step S200). That is, the control unit 20 acquires the information of the package for which the delivery request has been received via the communication unit 40. The information includes the dimensions of the package (the three-dimensional size that is minimum necessary when loading the package in the package compartment LC), the collection location, and the delivery location.

With a function of the determination unit 21b, the control unit 20 then acquires the delivery vehicle in which the package can be loaded (step S205). In the present embodiment, the delivery vehicles that are candidates for which a newly requested package is to be loaded are narrowed down. For example, the control unit 20 refers to the schedule information 30b recorded in the recording medium 30, and acquires the delivery vehicles that are within a predetermined range from the new package collection location as the candidates. Further, the control unit 20 acquires the available space information 30a indicating the current available space of each of the candidate delivery vehicles. Then, the control unit 20 compares each pieces of the available space information 30a and the dimensions of the new package, determines that the new package can be loaded in the available space when the dimensions are included in the available space, and acquires the delivery vehicle in which the new package can be loaded.

Next, with a function of the output unit 21c, the control unit 20 outputs the delivery vehicle in which the new package can be loaded (step S210). That is, the control unit 20 transmits the information indicating the delivery vehicle acquired in step S205 to the management terminal 200 via the communication unit 40. As a result, the management terminal 200 displays the delivery vehicle in which the new package can be loaded in the output unit of the user I/F unit 202. The manager designates the delivery vehicle in which the new package is to be loaded based on the display of the output unit of the user I/F unit 202, and information indicating the designated delivery vehicle is transmitted to the delivery support system 10. By receiving the information, the control unit 20 receives the designation of the delivery vehicle in which the new package is to be loaded (step S215).

The control unit 20 then transmits new schedule information to the delivery vehicle (step S220). That is, the control unit 20 searches for a route in which the collection location and the new package delivery location are added as the destination after the current location of the designated delivery vehicle. The control unit 20 then associates the searched route with the ID of the delivery vehicle, associates the order of visiting each destination, the handling type at each destination, and the package to be handled at each destination, and then updates the schedule information 30b. When the schedule information 30b is updated, the control unit 20 transmits the schedule information 30b via the communication unit 40 to the delivery support terminal 100 of the delivery vehicle whose schedule information 30b has been updated. The delivery support terminal 100 acquires the transmitted schedule information 30b and proposes the route indicated by the schedule information 30b.

### (4) Other Embodiments

The above embodiment is an example, and various other embodiments can be adopted as long as the available space is detected by the sensor attached to the package compartment. For example, the configuration may be such that a camera (a color camera, an infrared camera, or the like) capable of capturing the inside of the package compartment LC is attached to the package compartment LC and the captured image is transmitted to the delivery support system 10 and the management terminal 200. When the captured image is transmitted to the management terminal 200 and displayed, the manager can select the delivery vehicle to which the package is to be added based on the image of the inside of the package compartment.

Each system that configures the embodiment described above may be configured of fewer devices that share functions. As such an example, there is an example in which at least one system shown in FIG. 1 configures, together with one or more other systems, one device. For example, the delivery support system 10 and the delivery support terminal 100 may be configured as an integrated device, or the delivery support system 10 and the management terminal 200 may be configured as an integrated device. Further, a function of a part (for example, the available space detection unit 21a) of the delivery support system 10 may be realized by the delivery support terminal 100. Further, the system shown in FIG. 1 may be configured of a larger number of systems. For example, the delivery support system 10 may be configured of a cloud server.

At least a part of each unit (the available space detection unit 21a, the determination unit 21b, and the output unit 21c) that configures the delivery support system 10 may be divided into a plurality of devices. Further, a configuration in which a part of the configuration of the embodiment described above is omitted, or a configuration in which the processing is changed or omitted can be assumed.

The available space detection unit may be attached to the package compartment provided in the delivery vehicle and may detect the available space that is the space in which the package can be loaded based on the output signal of the package sensor that detects the three-dimensional region in which there is the package loaded in the package compartment. That is, the available space detection unit may be able to detect the available space that is the space in which there is no package by detecting the package with the package sensor.

The delivery vehicle is only required to be a vehicle capable of having the package loaded, and the configuration and the loading state are not limited. For example, the delivery vehicle may be a truck, a commercial vehicle such as a minivan or a van, or a passenger vehicle. The package sensor is only required to be able to three-dimensionally detect the region in the package compartment occupied by the package loaded in the package compartment. Only in this case, the package sensor is not limited to the infrared sensor as in the above embodiment. For example, the package sensor may be an ultrasonic sensor or various optical sensors, and various configurations can be adopted.

The three-dimensional region in which there is the package is the region in which the package fills the inside of the package compartment. Thus, for example, when the package is loaded in the package compartment, the three-dimensional region in which there is the package can be specified by specifying a part that is exposed to the outermost surface. The detection of the three-dimensional region in which there is the package is performed to detect the available space. Thus, the three-dimensional region in which there is the package is only required to be specified so that whether another package can be loaded, and the space in which the package cannot be additionally loaded does not have to be detected. For example, when a plurality of packages forms an interval in which a package cannot be loaded, it can be detected that the interval is filled with the package and the interval does not have to be detected.

The available space is only required to be a space in which the package can be loaded, and the space is only required to be detected as the available space when the package can be loaded in the space since a package in not in the space. Thus, if the package can be loaded, the available space may be a space above the package or may be a space expanding on the side of the package.

The determination unit is only required to be capable of determining whether the package to be added to the available space can be loaded based on the dimensions of the package to be added. That is, since the available space indicates the space in which the package can be loaded, the determination unit can determine whether the package to be added can be loaded in the available space by comparing the available space and the dimensions of the package, if the dimensions of the package are specified. The determination of whether the package can be loaded may be a determination of whether the space occupied by the package to be added and a part that can house a three-dimensional shape circumscribed on the package are included in the available space.

The output unit is only required to be capable of outputting the determination result of whether the package can be loaded. The output form of the determination result may be various forms, and a location at which the package can be loaded and the like may be output in addition to whether the package can be loaded. The collection location of the package, a time zone in which the package should be collected, the delivery location, and a time zone in which the package should be delivered etc. may be output. Further, the output destination is not limited to the user I/F unit of the management terminal, and may be a user I/F unit of the delivery person terminal used by the delivery person etc.

The technique of detecting the available space with the sensor attached to the package compartment as in the embodiment can be applied to a program or a method. The system, program, and method described above include various aspects such as those implemented using a single device and those implemented utilizing parts that are common to various members provided in the vehicle. Various changes may be made. For example, some units may be implemented using software, and others may be implemented using hardware. Further, a recording medium of a program for controlling a device can be provided. It is a matter of course that the recording medium of the software may be a magnetic recording medium or a semiconductor memory, and any recording medium to be developed in the future can be considered in the exact same way.

What is claimed is:

1. A delivery support system comprising:
an available space detection unit that detects an available space that is a space in which a package can be loaded based on an output signal of a package sensor that is attached to a package compartment provided in a delivery vehicle and that detects a three-dimensional region in which there is a package loaded in the package compartment;
a determination unit that determines whether a package to be added can be loaded in the available space based on dimensions of the package to be added; and
an output unit that outputs a determination result of whether a package can be loaded.

2. The delivery support system according to claim 1, wherein
the available space detection unit has a completion determination unit that determines whether a loading operation in the package compartment is completed, and
detection of the available space is executed when the completion determination unit determines that the loading operation in the package compartment is completed.

3. The delivery support system according to claim 1, wherein
the available space detection unit has a completion determination unit that determines whether an unloading operation from the package compartment is completed, and
detection of the available space is executed when the completion determination unit determines that the unloading operation from the package compartment is completed.

4. The delivery support system according to claim 1, further comprising a vibration detection unit that detects a vibration in the delivery vehicle based on an output signal of a vibration sensor attached to the delivery vehicle, and
detection of the available space is executed when the vibration exceeding a criterion is detected.

5. The delivery support system according to claim 1, wherein
the package sensor is attached to an inner wall of the package compartment provided in the delivery vehicle and detects a distance from the package sensor to a package.

6. The delivery support system according to claim 1, wherein
the package sensor is an infrared sensor.

7. A non-transitory computer-readable medium storing a delivery support program that causes a computer to function as:
an available space detection unit that detects an available space that is a space in which a package can be loaded based on an output signal of a package sensor that is attached to a package compartment provided in a delivery vehicle and that detects a three-dimensional region in which there is a package loaded in the package compartment;
a determination unit that determines whether a package to be added can be loaded in the available space based on dimensions of the package to be added; and
an output unit that outputs a determination result of whether a package can be loaded.
